(19) United States
(12) Patent Application Publication
(10) Pub. No.: US 2026/0267805 A1
(43) Pub. Date: Sep. 10, 2026

(54) METHOD FOR FASTER LOGICAL-TO-PHYSICAL TRANSLATION IN DATA STORAGE DEVICES

(71) Applicant: Sandisk Technologies, Inc., Milpitas, CA (US)

(72) Inventors: ABHINANDAN VENUGOPAL, BENGALURU (IN); VIVEK KUMAR, BENGALURU (IN); BHANU SHANKAR D G, BENGALURU (IN)

(73) Assignee: Sandisk Technologies, Inc., Milpitas, CA (US)

(21) Appl. No.: 19/071,931

(22) Filed: Mar. 6, 2025

(51) Int. Cl. G06F 12/1009

(52) U.S. Cl. CPC G06F 12/1009

(57) ABSTRACT

A storage device generates and uses a swift access table for translating a logical block address (LBA) to a physical address/jumbo block address (JBA) on a memory device. When updating a L2P table, a controller determines that data being updated belongs to a section in an mset that includes sequential data and sets continuity metadata for the section. During read-command processing, the controller determines that the continuity metadata for an associated mset is set to a predefined value and, when an entry for the mset is not loaded in the swift access table, the controller loads the entry in the swift access table. The controller calculates the JBA using a relative mset index and a relative JBA offset with respect to an anchor entry in the swift access table and transfers the JBA to the memory device to read the data.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in blocks on the memory device. The host may assign a logical block address (LBA) to data stored in blocks on the memory device, wherein the LBA is a unique identifier for a unit of data. The LBAs may be mapped one-to-one to physical addresses on the memory device. The one-to-one LBA to physical address mappings may be stored in a logical-to-physical (L2P) table. A controller on the storage device may manage the mapping of LBAs to physical locations within the memory device so that when the host issues a command to access a unit of data, the controller may retrieve the data based on the mappings in the L2P table.

A range of LBAs in the L2P table may be stored as an mset. The controller may cache a limited set of msets in a cache address table (CAT) in a volatile memory (for example, a random-access memory (RAM)) on the storage device. The CAT may be indexed linearly. If, for example, the host issues a read command, the controller may determine if the LBA in the read command is in an mset in the CAT. If it is, the controller may access the L2P information for the read command from the CAT.

During a host-write, if an mset is cached in the CAT, the mset may be updated, and if the mset is stored in the memory device, the controller may store the mset update in a temporary location (i.e., an update layer (ulayer)) that is not linearly indexed. The controller may accumulate updates in the ulayer and when the accumulated updates reach a threshold, the controller may trigger compaction to synchronize updates in msets in the ulayer with data in the CAT or the memory device. When performing a L2P translation for a LBA that is not in the CAT, the controller may figure out if the associated L2P entry exists in the ulayer by searching the entire ulayer. The controller may access information in the linearly indexed CAT more efficiently than in the non-linearly indexed ulayer.

RAM space may be limited and as such the size of the CAT may be restricted, particularly in storage devices that do not include large volatile memory, such as dynamic RAM (DRAM). As the capacity of the storage device increases, the range of LBAs in the storage device may also increase, even as the CAT size may remain the same. The controller may perform an L2P translation for an LBA that is in a msets that is not cached in the RAM (i.e., in the CAT or ulayer). For example, the L2P information for a LBA in a host command may be in a mset that is stored on a host memory buffer (HMB) or the memory device. The translation latency associated with translating the LBA to a physical address may be, for example, 180 nanoseconds(ns) when the mset including the LBA is cached in the CAT, 480ns when the mset is in the ulayer, greater than 600 ns when the mset is in the HMB, and about 20000ns when the mset is in the memory device.

Random-read/write benchmarks may be critical to the performance of the storage device. Storage devices may support different range requirements (for example, one gigabyte (GB), 32GB or 64GB random read/write benchmarks and may have different CAT budgets. When a storage device has to support a larger range of host workload as compared to its CAT size, the storage device may exhibit larger latencies and lower performance. In an example where the range of LBAs and size of the CAT is designed to support 1GB, an mset including a LBA in a host request may likely be stored in the CAT. In an example where the range of the LBAs is 32GB and the size of the CAT is designed to support 1GB, a limited set of msets (i.e., 1/32GB of msets) may be cached in the CAT. Hence, storage devices with limited RAM and/or large random-read benchmarks may execute a lower number of L2P translations from the CAT and experience higher translation latencies which may affect the performance of the storage device.

### SUMMARY OF THE INVENTION

In some implementations, a storage device may translate a logical block address to a physical address on a memory device using a swift access table. The storage device includes a memory including blocks for storing a logical-to-physical (L2P) table that includes a mapping of logical block addresses to physical addresses on the memory device. A controller on the storage device may receive a read command with a logical block address. The controller may determine that an entry for a mset including the logical block address is loaded in the swift access table and calculate the physical block address using a relative mset index and a relative jumbo block address (JBA) offset with respect to an anchor entry in the swift access table. The controller may transfer the physical block address to the memory device for the memory device to read the data associated with the logical block address

In some implementations, a method is provided on the storage device for. translating a logical block address to a physical address on a memory device using a swift access table in a storage device. The method includes receiving a read command with a logical block address. The method further includes determining that an entry for a mset including the logical block address is loaded in the swift access table and calculating the physical block address using a relative mset index and a relative jumbo block address (JBA) offset with respect to an anchor entry in the swift access table. The method also includes transferring the physical block address to a memory device for the memory device to read the data associated with the logical block address

In some implementations, a storage device may generate and use a swift access table in translating a logical block address to a physical address on a memory device,. The storage device includes a memory including blocks for storing a logical-to-physical (L2P) table that includes a mapping of logical block addresses to physical addresses on the memory device. The storage device also includes a controller to generate the swift access table when updating the L2P table. The controller determines that data being updated belongs to a section in an mset that includes sequential data and sets a continuity metadata for the section to a predefined first value. When the storage device receives a read command with a logical block address, the controller determines that the continuity metadata in a mset header for the mset is set to the first predefined value. The controller determines when an entry for the mset is not loaded in the swift access table and loads the entry for the mset in the swift access table. The controller calculates the physical block address using a relative mset index and a relative jumbo block address (JBA) offset with respect to an anchor entry in the swift access table and transfers the physical block address to the memory device for the memory device to read the data associated with the logical block address

### BRIEF DESCRIPTION OF THE DRAWINGS

FIG. 1 is a schematic block diagram of an example system in accordance with some implementations.

FIG. 2 is an example block diagram of a group of msets and the continuity metadata associated each mset in accordance with some implementations.

FIG. 3 is an example block diagram of a swift access logical-to-physical table in accordance with some implementations.

FIG. 4 is an example flow diagram for creating a swift access table and using the swift access table to translate a logical address in a random-read command to a physical address in a memory device in accordance with some embodiments. .

FIG. 5 is an example flow diagram for using a swift access table to calculate a physical address associated with a logical address in a random-read command in accordance with some embodiments.

FIG. 6 is a diagram of an example environment in which systems and/or methods described herein are implemented.

FIG. 7 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

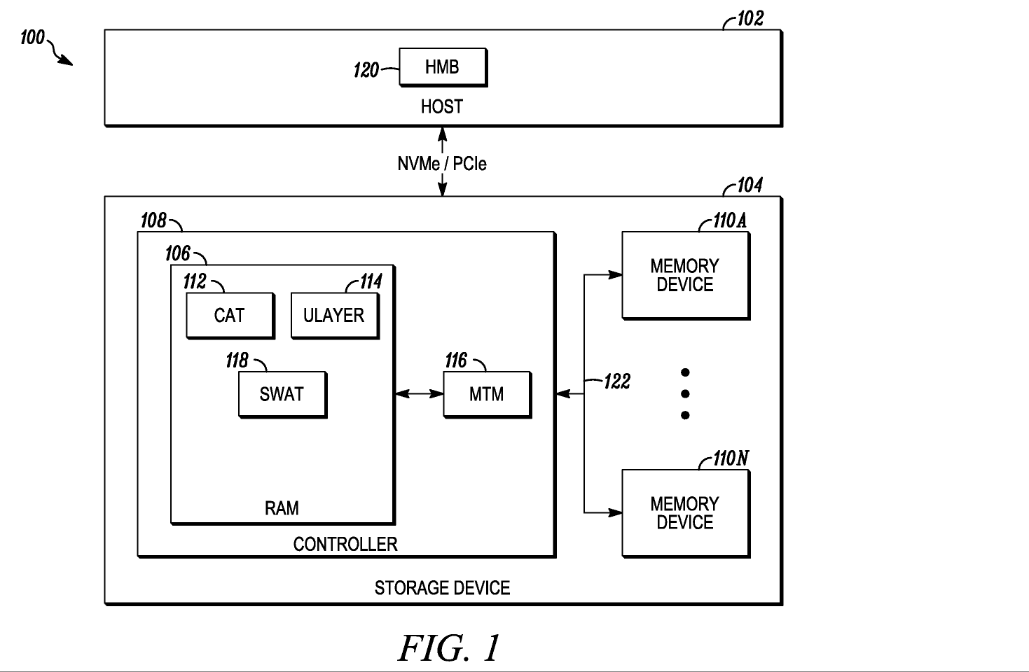

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may include a random-access memory (RAM) 106, a controller 108, and one or more storage components such as non-volatile memory devices 110a-110n (referred to herein as the memory device(s) 110). Storage device 104 may be, for example, a solid-state drive (SSD). RAM 106 may be, for example, static RAM (SRAM) or dynamic RAM (DRAM) that be used to temporarily store data on storage device 104. For example, RAM 106 may store portions of a logical-to-physical (L2P) table that may be used to map a logical block address (LBA) in a host command to a physical address on memory device 110.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include one or more dies connected to a memory bus 122 including data lines and chip enable lines. The dies may be divided into blocks and data may be stored in the blocks in various formats, with the formats being defined by the number of bits that may be stored per memory cell. Memory device 110 may be included in storage device 104 or may be otherwise communicatively coupled to storage device 104.

Storage device 104 may be expected to meet predefined random read benchmarks. For example, storage device 104 may be designed to meet a standard 1GB random read/write performance benchmark and may include a 1 mega-byte (MB) cache address table (CAT) 112. CAT 112 may include a limited number, for example, thirty-two, of slots, that may support the 1GB workload range. Storage device 104 may also be designed to meet long range random-read workloads, for example, 32GB or 64GB random-read workloads. In an example where storage device 104 supports a 32GB random-read workload and includes a 1MB CAT 112, only 1/32GB msets may be cached in CAT 112 at a time (i.e., because a 1MB CAT 112 may support a 1GB range). Similarly, in an example where storage device 104 supports a 64GB random-read workload and includes a 1MB CAT 112, only 1/64GB msets may be cached in CAT 112 at a time.

In a conventional approach, when performing an L2P translation for a host random-read request, controller 108 may first refer to CAT 112. As part of a L2P translation, controller 108 may check a CAT header for an mset identifier to determine if a slot in CAT 112 includes the mset that has the LBA in the random-read request. If the mset is in CAT 112, controller 108 may check an erase bitmap to determine if the mset is erased, lock the slot in CAT 112 before performing the L2P translation to prevent another command from evicting the data in the slot, and check the slot for an invalid Uncorrectable Error Correction Code (UECC). Controller 108 may thereafter translate the LBA to a physical address based on the information obtained from CAT 112. If the mset including the LBA in the random-read request is not in CAT 112, controller 108 may check an update layer (ulayer 114) that may include unlinked L2P updates.

If the associated mset is not in CAT 112 or unlayer 114, controller 108 may determine if the mset is stored in a host memory buffer (HMB) 120. HMB 120 may be a buffer on host 102 that may be used by storage device 104, wherein storage device may cache portions of the L2P table in HMB 120. Accessing the L2P information from HMB 120 may incur host protocol latencies. As a last resort, if the mset including the LBA in the random-read request is not in CAT 112, ulayer 114, or HMB 120, controller 108 may have the mset loaded from memory device 110 to CAT 112 to perform the L2P translation. Using this conventional approach, about thirty-five percent of the processing time for a random-read command may be used for L2P translation, which may be a bottleneck for random-read performance.

Consider an example where in using the conventional approach host 102 issues a first random-read command. Controller 108 may process the first random-read command by determining if a mset including the LBA in the first random-read command is in CAT 112 or ulayer 114. If the mset is not in CAT 112 or ulayer 114, controller 108 may invoke management table module (MTM) 116 to load the mset from memory device 110 into CAT 112. When the mset is loaded into CAT 112, controller 108 may linearly index the msets in CAT 112 to obtain the logical-to-physical translation. Controller 108 may transfer the read command with the physical address to memory device 110 for memory device 110 to execute the read operation.

When host 102 issues a second random-read command that has an LBA in the same mset as the LBA in the first random-read command, in performing the L2P translation, controller 108 may obtain the L2P entry for the LBA in the second random-read command from CAT 112. Controller 108 may issue the second random-read command with the physical address to memory device 110, wherein memory device 110 may execute the command and read the data from the physical address associated with LBA in the second random-read command.

If the second random-read command includes an LBA that is not in the same mset as the LBA in the first random-read command, the LBA in the second random-read command may or may not be in CAT 112. When the LBA is not in CAT 112, controller 108 may search the ulayer 114 and possibly invoke MTM 116 to load the mset including the LBA in the second random-read command into CAT 112.

In an implementation, when controller 108 is updating the L2P table by, for example, executing a host write command or performing L2P consolidation using the updates in ulayer 114, controller 108 may determine if the data being updated belongs to a section, in a given mset, that includes sequential data. Controller 108 may, for example, determine if the data being updated is a continuation of data from a previous write operation based on a physical block offset. As such, when controller 108 is writing host data or updating deltas in ulayer 114, controller 108 may determine if the target physical location is sequential to the previous physical location. If at the end of a section in the mset, controller 108 determines that the section includes only sequential data, controller 108 may set a bit (also referred to herein as continuity metadata), for the section in a mset header, to a predefined first value.

Storage device 104 may include a swift access table (SWAT) 118 that may a mset to block address mapping table for the msets included in SWAT 118. The first entry loaded in SWAT 118 is an anchor entry that may be indexed at index 0. Subsequent entries loaded into SWAT 118 may be displaced with an appropriate count of msets from the anchor entry. Loading of SWAT 118 thus ensures relative mset positions with respect to the anchor mset.

An entry in SWAT 118 may be associated with the continuity metadata for a section in an mset, wherein the continuity metadata may indicate data continuity with respect to a physical address (also referred to herein as a jumbo block address (JBA)) within a given mset. SWAT 118 may store one or more entries for a mset based on a data continuity bitmap configuration. The size of SWAT 118 may be configurable based on a detected/targeted workload range. For example, a 260-byte SWAT 118 may accommodate a 1GB workload range, a 8kilobyte (KB) SWAT 118 may accommodate a 32GB range and a 16KB slot may accommodate a 64KB range.

When translating a LBA in a random read request to physical address by accessing the L2P information in CAT 112, ulayer 114, HMB, or memory device 110, controller 108 may referred to the continuity metadata in a mset header for the mset including the LBA in the random read request. If the continuity metadata is set to indicate that a section of the mset includes sequential data or that the entire mset includes sequential (i.e., if the continuity metadata for a section is set to the first predefined value), the mset and the JBA for the first LBA-JBA mapping for the section that includes sequential data may be loaded into SWAT 118. Other JBAs in the section may not be loaded into SWAT 118. Controller 108 may translate the LBA in the random read request to a physical address in SWAT 118 using a relative mset index and relative JBA offset with respect to the anchor entry in SWAT 118.

Consider an example where host 102 issues a first random-read command. In translating the LBA in the first random-read command to a physical address, controller 108 may determine if a mset including the LBA is loaded in CAT 112 or ulayer 114. If the mset is not in CAT 112 or ulayer 114, controller 108 may invoke MTM 116 to load the mset from memory device 110 into CAT 112. When the mset is loaded into CAT 112, controller 108 may linearly index CAT 112 to obtain the mset. Controller 108 may determine if the continuity metadata in the mset header is set to the first predefined value, and if it is, load the mset and the JBA in the first LBA-JBA mapping in the mset into SWAT 118.

Controller 108 may determine where the LBA in the first random-read command falls in the range of LBAs in the mset and calculate an offset for the LBA in the first random-read command based on the JBA loaded into SWAT 118. For example, the first random-read command may include a LBA in mset 38, mset 38 may include LBAs 101-200, and the LBA in the first random-read command may be LBA 166. Controller 108 may determine that the LBA in the first random-read command is in mset 38 and may calculate the offset for the LBA to be 66. Controller 108 may calculate a targeted physical address (JBA) for the LBA to be the sum of a physical address at a relative mset index with respect to the anchor entry in SWAT 118 plus the offset. Controller 108 may transfer the read command with the calculated physical address to memory device 110 for memory device 110 to execute the read operation.

If host 102 issues a second random-read command with a LBA in an mset that is already loaded into SWAT 118, in performing the L2P translation, controller 108 may determine that the mset including the LBA in the second random-read command is loaded in SWAT 118. Controller 108 may calculate the targeted physical address for the LBA in the second random-read command and transfer the read command with the calculated physical address to memory device 110 for memory device 110 to execute the read operation.

If the LBA in the second random-read command is in an mset that is not loaded in SWAT 118, controller 108 may obtain the L2P entry for the LBA from CAT 112. Controller 108 may access an mset in CAT 112 and determine if the continuity metadata in the mset header is set to the first value. If the continuity metadata is set, controller 108 may load the mset and the JBA in the first LBA-JBA mapping in the mset into SWAT 118. If the mset is not in CAT 112, controller 108 may search ulayer 114 for the mset with the LBA in the second random-read command. If the mset is in ulayer 114, controller 108 may determine if the continuity metadata for the mset is set to the first value, and if it is, load the mset and the JBA in the first LBA-JBA mapping in the mset into SWAT 118. When the mset including the LBA in the second random-read command is loaded into SWAT 118, controller 108 may calculate the targeted physical address for the LBA and transfer the read command with the calculated physical address to memory device 110 for memory device 110 to execute the read operation

If the mset with the LBA in the second random-read command is not in ulayer 114, controller 108 may invoke MTM 116 to load the mset including the LBA in the second random-read command into CAT 112 and perform the L2P translation operations associated with processing an mset in CAT 112. Controller 108 may determine if the continuity metadata in the mset header is set, and if it is, load the mset and the JBA in the first LBA-JBA mapping in the mset into SWAT 118. When the mset including the LBA in the second random-read command is loaded into SWAT 118, controller 108 may calculate the targeted physical address for the LBA and transfer the read command with the calculated physical address to memory device 110 for memory device 110 to execute the read operation

SWAT 118 may be an on-demand random-read targeted table that may be stored in RAM 106 or a Data Closely Coupled Memory (DCCM) (not shown) on storage device 104. An mset may be loaded in SWAT 118 once and thereafter L2P translations may be carried out for LBAs in the mset from SWAT 118, irrespective of the random workload range. Translation from each entry in SWAT 118 involves executing an equation to calculate the targeted physical address and the translations of random data may be instantaneous. In some cases, once an LBA is determined to be in SWAT 118, controller 108 or a hardware processor may calculate the targeted physical address. Storage device 104 may use less processing power in calculating the targeted physical address based on the entries in SWAT 118. For example, the latency associated with calculating the targeted physical address based on the information in SWAT 118 may be 80ns, which is less than the 180ns latency associated with L2P translation through CAT 112. The reduced read command overhead may help to improve the random-read performance on storage device 104. As SWAT 118 is a dynamic table, the same memory may be used for other purposes in different workload contents.

Storage device 104 may perform these processes based on a processor, for example, controller 108 executing software instructions stored by a non-transitory computer-readable medium, such as storage component/memory device 110. As used herein, the term “computer-readable medium” refers to a non-transitory memory device. Software instructions may be read into storage component 110 from another computer-readable medium or from another device. When executed, software instructions stored in storage component 110 may cause controller 108 to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

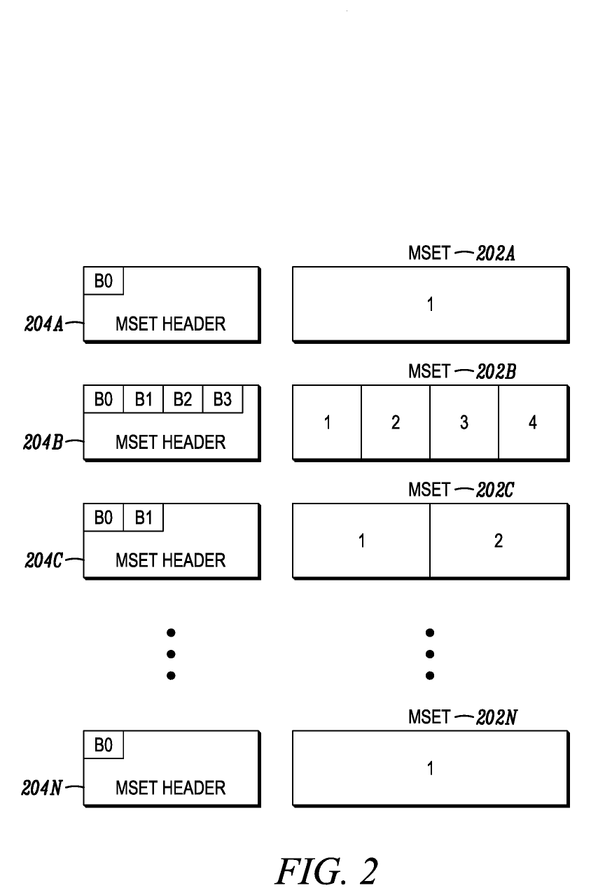

FIG. 2 is an example block diagram of a group of msets and the continuity metadata associated each mset in accordance with some implementations. Each mset 202a-202n (referred to herein as mset 202) has an associated mset header 204a-204n (referred to herein as mset header 204). Each mset may include one or more sections (shown, for example, as 1-4). For example, msets 202a and 202n include one section, mset 202b includes four sections, and mset 202c includes two sections. Each section in mset 202 has an associated bit in mset header 204. As such, mset headers 204a and 204n have only one bit (B0) because msets 202a and 202n are not divided into sections, mset headers 204b has four bits (B0, B1, B2, B3) because mset 202b is divided into four sections, and mset header 204c has two bits (B0 B1) because mset 202c is divided into two sections. For example, B0 in mset header 204a is associated with mset 202a and B0 in mset header 204n is associated with mset 202n. B0 in mset header 204b is associated with section one in mset 202b, B1 in mset header 204b is associated with section two in mset 202b, B2 in mset header 204b is associated with section three in mset 202b, and B3 in mset header 204b is associated with section four in mset 202b. B0 in mset header 204c is associated with section one in mset 202c and B1 in mset header 204c is associated with section two in mset 202c.

When controller 108 is updating the L2P table or during L2P consolidation, controller 108 may determine if the data in a section is sequential. If, at the end of a section, controller determines that the data in the section is sequential, controller 108 may set the continuity metadata in mset header 204. For example, if during a L2P write update of L2P consolidation, at the end of mset 202a, controller 108 determines that the data in mset 202a is sequential, controller 108 may set B0 in mset header 204a to a first predefined value. If during an L2P write update of L2P consolidation, at the end of the first, third, and fourth sections in mset 202b, controller 108 determines that the data in the first, third, and fourth sections in mset 202b is sequential, controller 108 may set B0, B2 and B3 in mset header 204b to the first value. If during a L2P write update of L2P consolidation, at the end of the second section in 202b, controller 108 determines that the data in the second section in mset 202b is not sequential, controller 108 may not set B1 in mset header 204b to the first value. Controller 108 may perform similar evaluations of the other msets and set the continuity metadata in the associated mset header as appropriate. As indicated above FIG. 2 is provided as an example. Other examples may differ from what is described in FIG. 2.

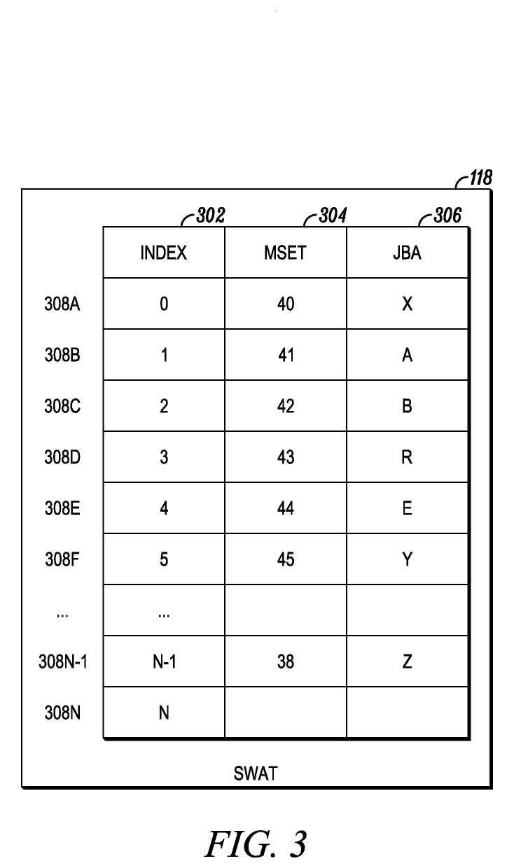

FIG. 3 is an example block diagram of a swift access logical-to-physical table in accordance with some implementations. The entries in SWAT 118 include an index field 302, mset field 304, and a JBA field 306. The first entry 308a in SWAT 118 is an anchor entry that may be indexed at index 0. Anchor entry 308a includes a mset identifier, i.e., mset id 40, for the mset in mset field 304. Anchor entry 308a may include a physical address (X) for the first LBA-JBA mapping for a section in mset 40 that includes sequential data. Subsequent entries 308b-308n in SWAT 118 may be displaced with an appropriate count of msets from anchor entry 308a. For example, entries 308b-308f may include the mset id and (JBA) for the first LBA-JBA mapping for a section in the mset in that entry that includes sequential data. As such, entry 308b may include the mset identifier for mset 41 in mset field 304 and (JBA) for the first LBA-JBA mapping for a section in mset 41, entry 308c may include the mset identifier for mset 42 in mset field 304 and (JBA) for the first LBA-JBA mapping for a section in mset 42, entry 308d may include the mset identifier for mset 43 in mset field 304 and (JBA) for the first LBA-JBA mapping for a section in mset 43, entry 308e may include the mset identifier for mset 44 in mset field 304 and (JBA) for the first LBA-JBA mapping for a section in mset 44, and entry 308f may include the mset identifier for mset 45 in mset field 304 and (JBA) for the first LBA-JBA mapping for a section in mset 45. Entries 308b-308f show the relative positioning of the mset identifier with respect to the anchor entry in a forward direction. Entry 308n-1 shows the relative positioning of the mset identifier with respect to the anchor entry in a reverse direction.

SWAT 118 may store one or more entries for a mset based on a data continuity bitmap configuration. The size of SWAT 118 may be configurable based on a detected/targeted workload range. For example, a 260-byte SWAT 118 may accommodate a 1GB workload range, a 8kilobyte (KB) SWAT 118 may accommodate a 32GB range and a 16KB slot may accommodate a 64KB range. As indicated above FIG. 3 is provided as an example. Other examples may differ from what is described in FIG. 3.

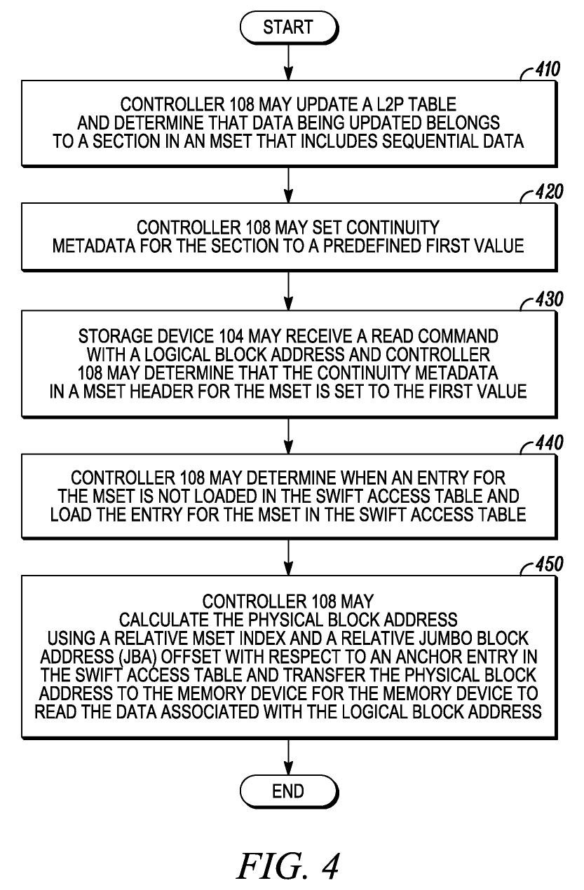

FIG. 4 is an example flow diagram for creating a swift access table and using the swift access table to translate a logical address in a random-read command to a physical address in a memory device in accordance with some embodiments. At 410, controller 108 may update a L2P table and determine that data being updated belongs to a section in an mset that includes sequential data. At 420, controller 108 may set continuity metadata for the section to a predefined first value. At 430, storage device 104 may receive a read command with a logical block address and controller 108 may determine that the continuity metadata in a mset header for the mset is set to the first value. At 440, controller 108 may determine when an entry for the mset is not loaded in the swift access table and load the entry for the mset in the swift access table. At 450, controller 108 may calculate the physical block address using a relative mset index and a relative jumbo block address (JBA) offset with respect to an anchor entry in the swift access table and transfer the physical block address to the memory device for the memory device to read the data associated with the logical block address As indicated above FIG. 4 is provided as an example. Other examples may differ from what is described in FIG. 4.

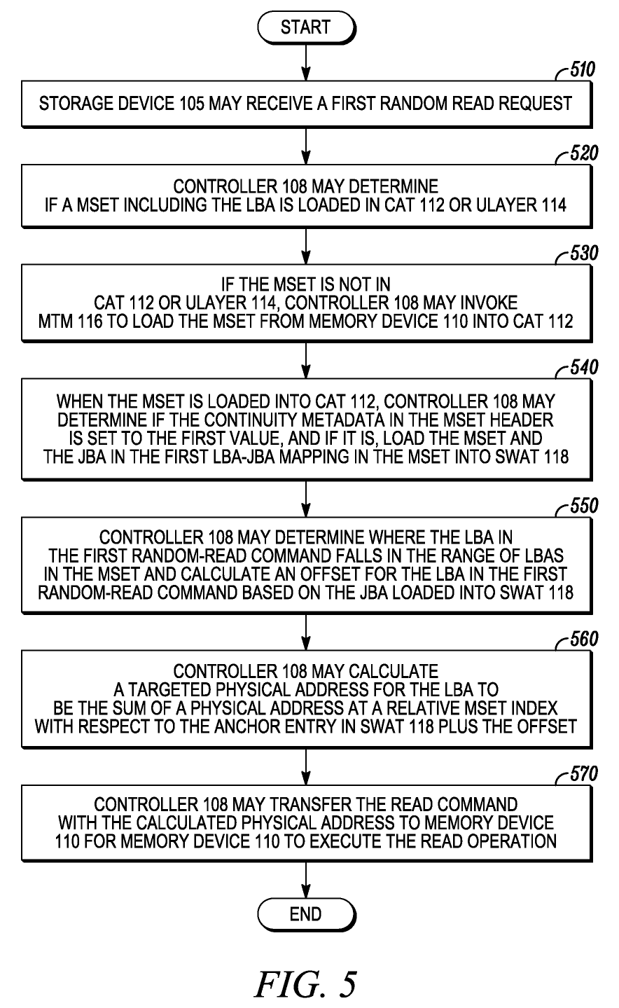

FIG. 5 is an example flow diagram for using a swift access table to calculate a physical address associated with a logical address in a random-read command in accordance with some embodiments. At 510, storage device 104 may receive a first random-read command. At 520, controller 108 may determine if a mset including the LBA is loaded in CAT 112 or ulayer 114. At 530, if the mset is not in CAT 112 or ulayer 114, controller 108 may invoke MTM 116 to load the mset from memory device 110 into CAT 112. At 540, when the mset is loaded into CAT 112, controller 108 may determine if the continuity metadata in the mset header is set to the first value, and if it is, load the mset and the JBA in the first LBA-JBA mapping in the mset into SWAT 118. At 550, controller 108 may determine where the LBA in the first random-read command falls in the range of LBAs in the mset and calculate an offset for the LBA in the first random-read command based on the JBA loaded into SWAT 118.

For example, turning to FIG. 3, if the first random-read command includes a LBA in mset 38 at offset 445, controller 108 may calculate a targeted physical address for the LBA to be the sum of a physical address at a relative mset index with respect to the anchor entry in SWAT 118 (i.e., JBA Z in entry 308n) plus the offset (i.e., controller 108 may calculate the targeted physical address to be a JBA Z plus 445), at 560. At 570, controller 108 may transfer the read command with the calculated physical address to memory device 110 for memory device 110 to execute the read operation. As indicated above FIG. 5 is provided as an example. Other examples may differ from what is described in FIG. 5.

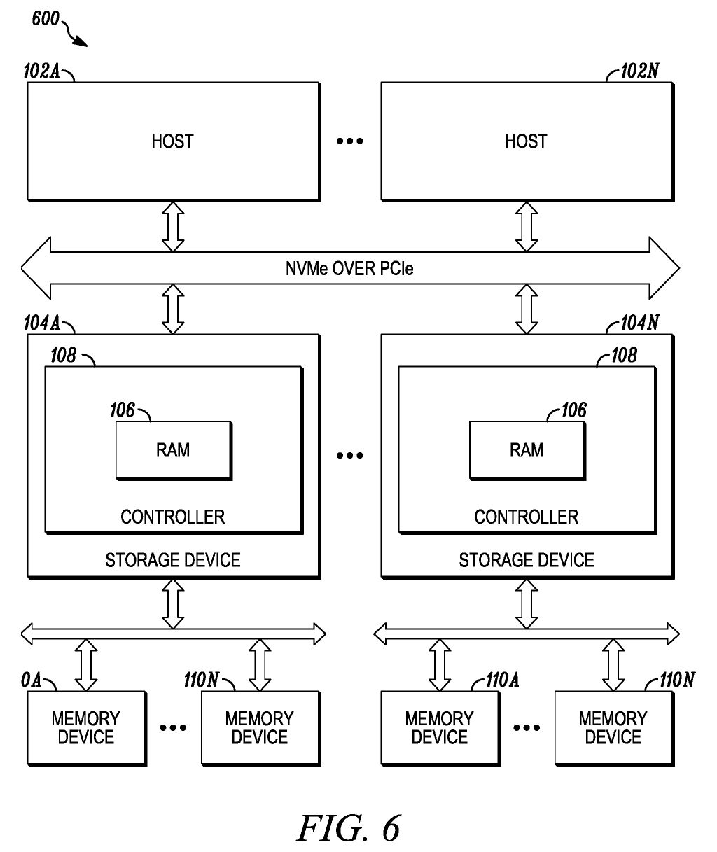

FIG. 6 is a diagram of an example environment in which systems and/or methods described herein are implemented. As shown in FIG. 6, Environment 600 may include hosts 102-102n(referred to herein as host(s) 102), and one or more storage devices 104a-104n (referred to herein as storage device(s) 104). Controller 108 may translate a logical block address to a physical address on a memory device using a swift access table. Hosts 102 and storage devices 104 may communicate via Non-Volatile Memory Express (NVMe) over peripheral component interconnect express (PCI Express or PCIe), SD, or the like.

Devices of Environment 600 may interconnect via wired connections, wireless connections, or a combination of wired and wireless connections. For example, the network in FIG. 6 may include NVMe over Fabric(NVMe-oF) Internet Small Computer Systems Interface (iSCSI), Fibre Channel (FC), Fibre Channel Over Ethernet (FCoE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of Environment 600 may perform one or more functions described as being performed by another set of devices of Environment 600.

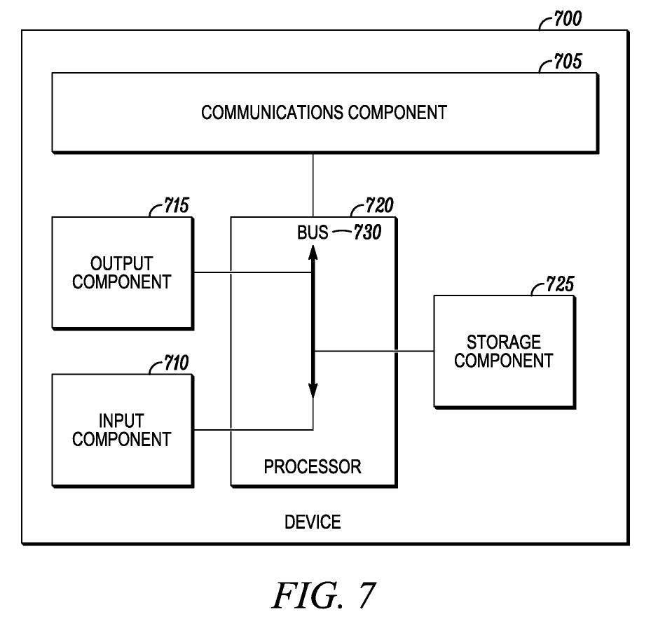

FIG. 7 is a diagram of example components of one or more devices of FIG. 1. In some implementations, host 102 may include one or more devices 700 and/or one or more components of device 700. Device 700 may include, for example, a communications component 705, an input component 710, an output component 715, a processor 720, a storage component 725, and a bus 730. Bus 730 may include components that enable communication among multiple components of device 700, wherein components of device 700 may be coupled to be in communication with other components of device 700 via bus 730.

Input component 710 may include components that permit device 700 to receive information via user input (e.g., keypad, a keyboard, a mouse, a pointing device, and a network/ data connection port, or the like), and/or components that permit device 700 to determine the location or other sensor information (e.g., an accelerometer, a gyroscope, an actuator, another type of positional or environmental sensor). Output component 715 may include components that provide output information from device 700 (e.g., a speaker, display screen, and network/ data connection port, or the like). Input component 710 and output component 715 may also be coupled to be in communication with processor 720.

Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 may include one or more processors capable of being programmed to perform a function. Processor 720 may be implemented in hardware, firmware, and/or a combination of hardware and software.

Storage component 725 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 720. A memory device may include memory space within a single physical storage device or memory space spread across multiple physical storage devices. Storage component 725 may also store information and/or software related to the operation and use of device 700. For example, storage component 725 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 705 may include a transceiver-like component that enables device 700 to communicate with other devices, such as via a wired connection, a wireless connection, or a combination of wired and wireless connections. The communications component 705 may permit device 700 to receive information from another device and/or provide information to another device. For example, communications component 705 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 705 may also include one or more broadband and/or narrowband transceivers and/or other similar types of wireless transceiver configurable to communicate via a wireless network for infrastructure communications. Communications component 705 may also include one or more local area network or personal area network transceivers, such as a Wi-Fi transceiver or a Bluetooth transceiver.

Device 700 may perform one or more processes described herein. For example, device 700 may perform these processes based on processor 720 executing software instructions stored by a non-transitory computer-readable medium, such as storage component 725. As used herein, the term “computer-readable medium” refers to a non-transitory memory device. Software instructions may be read into storage component 725 from another computer-readable medium or from another device via communications component 705. When executed, software instructions stored in storage component 725 may cause processor 720 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, or “contains …a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device to translate a logical block address to a physical address on a memory device using a swift access table, the storage device comprises:
a memory including blocks to store a logical-to-physical (L2P) table that includes a mapping of logical block addresses to physical addresses on the memory device; and
a controller to receive a read command with a logical block address, determine that an entry for a mset including the logical block address is loaded in the swift access table, calculate the physical block address using a relative mset index and a relative jumbo block address (JBA) offset with respect to an anchor entry in the swift access table, and transfer the physical block address to the memory device for the memory device to read data associated with the logical block address.

2. The storage device of claim 1, wherein the controller obtains the mset from a volatile memory on the storage device, determines that continuity metadata in a mset header for the mset is set to a first predefined value, determines that an entry for the mset is not loaded in the swift access table, and loads the entry for the mset in the swift access table.

3. The storage device of claim 1, wherein the swift access table is an mset to block address mapping table for the msets included in the swift access table.

4. The storage device of claim 1, wherein a first entry in the swift access table is the anchor entry, wherein the anchor entry is indexed at index zero and other entries in the swift access table are displaced with an appropriate count of msets from the anchor entry.

5. The storage device of claim 1, wherein an entry in the swift access table is associated with continuity metadata for a section in the mset.

6. The storage device of claim 1, wherein an entry in the swift access table includes a mset identifier and the JBA for a first logical block address to JBA mapping for a section in the mset that includes sequential data.

7. The storage device of claim 1, wherein a size of the swift access table is configurable based on a targeted workload range.

8. The storage device of claim 1, wherein the controller calculates the physical block address to be a sum of a physical address at the relative mset index with respect to an anchor entry in the swift access table plus the JBA offset.

9. A method for translating a logical block address to a physical address on a memory device using a swift access table in a storage device, the storage device comprises a controller to execute the method comprising:
receiving a read command with a logical block address;
determining that an entry for a mset including the logical block address is loaded in the swift access table;
calculating the physical block address using a relative mset index and a relative jumbo block address (JBA) offset with respect to an anchor entry in the swift access table; and
transferring the physical block address to a memory device for the memory device to read data associated with the logical block address.

10. The method of claim 9, further comprising obtaining the mset from a volatile memory on the storage device, determining that continuity metadata in a mset header for the mset is set to a first predefined value, determining that an entry for the mset is not loaded in the swift access table, and loading the entry for the mset in the swift access table.

11. The method of claim 9, further comprising indexing a first entry in the swift access table at index zero, using the first entry as an anchor entry, and displacing other entries in the swift access table with an appropriate count of msets from the anchor entry.

12. The method of claim 9, further comprising associating an entry in the swift access table with continuity metadata for a section in the mset.

13. The method of claim 9, further comprising including a mset identifier and the JBA for a first logical block address to JBA mapping for a section in the mset that includes sequential data in an entry in the swift access table.

14. The method of claim 9, further comprising updating a logical-to-physical table, determining that data being updated belongs to a section in the mset that includes sequential data and setting continuity metadata for the section to a predefined first value.

15. The method of claim 9, further comprising configuring a size of the swift access table based on a targeted workload range.

16. The method of claim 9, further comprising calculating the physical block address to be a sum of a physical address at the relative mset index with respect to an anchor entry in the swift access table plus the JBA offset.

17. A storage device to generate and use a swift access table in translating a logical block address to a physical address on a memory device, the storage device comprises:
a memory including blocks to store a logical-to-physical (L2P) table that includes a mapping of logical block addresses to physical addresses on the memory device; and
a controller to:
update the L2P table, determine that data being updated belongs to a section in an mset that includes sequential data, set a continuity metadata for the section to a predefined first value, and
receive a read command with a logical block address, determine that the continuity metadata in a mset header for the mset is set to the first predefined value, determine when an entry for the mset is not loaded in the swift access table and load the entry for the mset in the swift access table, calculate the physical block address using a relative mset index and a relative jumbo block address (JBA) offset with respect to an anchor entry in the swift access table, and transfer the physical block address to the memory device for the memory device to read the data associated with the logical block address.

18. The storage device of claim 17, wherein the controller determines if data being updated is a continuation of data from a previous write operation based on a physical block offset and, when at an end of a section in the mset the controller determines that the section includes sequential data, the controller sets the continuity metadata, for the section to the predefined first value.

19. The storage device of claim 17, wherein an entry for a section in the mset is loaded in the swift access table once and translations are carried out for logical block addresses in the mset from the swift access table, irrespective of a random workload range.

20. The storage device of claim 17, wherein when the mset includes multiple sections, an entry for a section is loaded in the swift access table once.
